(19) United States
(12) Patent Application Publication
(10) Pub. No.: US 2002/0138989 A1
(43) Pub. Date: Oct. 3, 2002

(54) Rotary cutter

(76) Inventors: Vincent T. Kozyrski, Plainville, CT (US); Donald B. Effgen, Guilford, CT (US)

Correspondence Address: RICHARD D. GETZ, McCormick, Paulding & Huber, City Place II, 185 Asylum Street, Hartford, CT, 06103-3402, US

(21) Appl. No.: 09/822,136

(22) Filed: Mar. 30, 2001

(51) Int. Cl. B26B 25/00

(52) U.S. Cl. 30/164.95

(57) ABSTRACT

A rotary cutter for cutting thin sheet materials is provided that includes a support member and a circular cutting blade pivotally mounted to the support member. The circular cutting blade includes a cutting edge, a diameter, and a thickness. The cutting blade has a diameter that is not greater than about fifteen times the thickness of the cutting blade. According to an aspect of the present invention rotary cutter, the cutting blade is clip mounted and the clip is removably attached to the support member.

### BACKGROUND OF THE INVENTION

1. Technical Field

This invention relates to cutting tools for use with thin sheet materials in general, and to hand-held rotary cutting tools for use with thin sheet materials in particular.

2. Background Information

A hand-held rotary cutting tool is an effective tool for cutting thin sheet materials such as paper, cloth, and plastic. Rotary cutting tools typically will not pull thin sheet material like a dull razor will, and do not have a sharp point like many razor knifes. Presently available rotary cutting tools designed to cut thin sheet materials typically include a handle, a thin circular blade, and a bladeguard. The blade is pivotally mounted on a post that is attached to the handle, or alternatively fixed to a shaft that is pivotally mounted to the handle. Presently available rotary cutters have a very thin, large diameter blade with a sharp angle, razor-type cutting edge. The thickness to diameter ratio for these type blades generally exceeds 1 to 100, and is very often greater than 1 to 150. Very thin, large diameter blades cut well initially, but their thin, sharp edge limits their durability. In addition, their thinness and large diameter make them susceptible to warpage, bending, or fracture, any of which can cause damage to the material being cut.

Another disadvantage associated with the large diameter is the nip point created between the blade and the surface being cut. A large diameter cutting blade creates a larger nip than does a small diameter blade, consequently increasing the chance that some thing will get caught in the nip.

A large diameter rotary cutter also requires more downward force than a small diameter rotary cutter to achieve the same amount of force per unit cutter length in contact with the material because the applied force is distributed over a longer length. The length over which the force is distributed increases with diameter because more of the cutter blade circumference is engaged with the material to be cut. A cutting tool that can cut material with less force than similar tools will likely be more desirable.

In many instances it is desirable to cut thin sheet material along a small radius or other sharp turn. Sharp turns made with a large diameter cutting blade will often cause the material being cut to bunch because of the relatively long length of cutting edge engaged with the material. The bunching can result in an uneven cut or disfigurement of the material. A cutting tool that can cut sharp turns in thin sheet material without damaging the material will likely be more desirable.

What is needed, therefore, is a rotary cutting tool capable of cutting thin sheet material that is durable, safe to use, one that requires minimal operator force, and one that can cut sharp turns in a material without damage.

### DISCLOSURE OF THE INVENTION

It is, therefore, an object of the present invention to provide a rotary cutting tool that is durable, safe and easy to use, and one capable of cutting sharp turns in material without damage.

According to the present invention, a rotary cutter for cutting thin sheet materials is provided that includes a handle or other support-type member and a circular cutting blade pivotally mounted to the handle (or member). The circular cutting blade includes a cutting edge, a diameter, and a thickness. The cutting blade has a diameter that is not greater than about fifteen times the thickness of the cutting blade. According to an aspect of the present invention rotary cutter, the cutting blade is clip mounted and the clip is removably attached to the handle.

The present invention rotary cutter provides several advantages over existing thin sheet material cutters. As stated above, presently available rotary cutters have several drawbacks relating to safety, durability, and ease of use. The present invention rotary cutter overcomes the safety issues of the large diameter blades by using a cutting blade that has a much smaller diameter than is used in existing rotary cutter blades, and one that has a much broader edge angle than is found on existing rotary cutting blades. In contrast to the very sharp razor edge of existing rotary cutter blades, the edge angle of the present invention cutting blade is in the range of about forty (40) to fifty (50) degrees. The much smaller diameter increases the safety by greatly decreasing the size of the nip between the cutter and the material being cut, consequently minimizing the opportunity for something to get caught in the nip. The broad edge angle of the present cutting blade also makes the cutter safer to use, while still effective as a thin sheet material cutter. A compliant material that is easily cut by a razor-type blade, for example, will not readily be cut by the present blade because thickness of the present blade engages more material. A thin sheet material resting on top of a hard surface, in contrast, is easily cut by the present cutter because only the point portion of the blade's cutting edge engages the material.

The present invention rotary cutter also provides advantageous durability. As stated earlier, rotary cutters with a thin, razor-edged cutting blade are susceptible to damage and dulling. The present rotary cutter utilizes a relatively thick cutting blade that has a cutting edge with a broad edge angle. The cutting edge, which is formed via the broad edge angle extending side to side across the thickness of the blade, provides additional material to support the portion of the cutting edge engaged with the material being cut and is therefore less susceptible to damage (i.e., warpage, fracture, etc.). The relatively substantial thickness and the small diameter also allow for cost-effective manufacturing techniques that increase the hardness and therefore the durability of the cutting edge. Specifically, the cutting blade of the present rotary cutter is preferably coined from strip stock. The material in the region of the cutting edge is work hardened during the coining process and subsequently ground to the broad edge angle.

The present invention rotary cutter also provides advantageous ease of use. Because the diameter of the present rotary cutter is relatively small, the cutting edge engaged with the material to be cut is also relatively small. The force applied by the operator is therefore concentrated along a limited length, and the amount of required force is advantageously limited. The limited length of the cutting edge engaged with the material being cut also facilitates sharp turns and avoids undesirable bunching of the material, both of which improve the cutter's ease of use.

These and other objects, features, and advantages of the present invention will become apparent in light of the detailed description of the present invention.

### BRIEF DESCRIPTION OF THE DRAWINGS

FIG. 1 is a diagrammatic view of an embodiment of a present invention rotary cutter.

FIG. 2 is a diagrammatic view of another embodiment of a present invention rotary cutter.

FIG. 3 is a side view of a present invention cutting blade.

FIG. 4 is a sectioned view of the cutting blade shown in FIG.3, sectioned along line 4-4.

FIG. 5 is a diagrammatic side view of a present invention cutter blade mounted on a clip.

FIG. 6 is a diagrammatic front view of the cutter blade shown in FIG. 5.

### DETAILED DESCRIPTION OF THE INVENTION

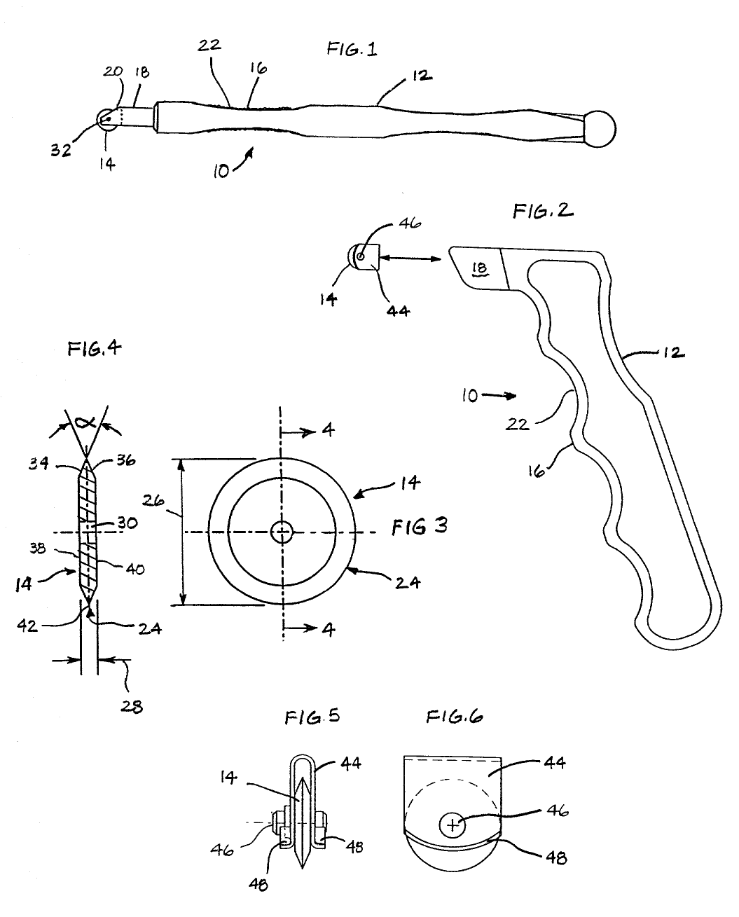

Now referring to FIGS. 1 and 2, a hand-held rotary cutter 10 for thin sheet materials includes a handle 12 and a circular cutting blade 14. The handle 12 includes a hand grip portion 16 and a head portion 18. A slot 20 is disposed in the head portion 18 for receiving the cutting blade 14. In one embodiment (FIG. 1), the grip portion 16 and the head portion 18 are substantially aligned along a straight line. In another embodiment (FIG. 2), the head portion 18 is disposed at an angle to the grip portion 16. In both embodiments, the grip portion 16 includes contoured surfaces 22 for the operator to position fingers against to improve the operator's grip on the cutter 10. Alternative style handles may also be used with the present invention rotary cutter 10.

Referring to FIGS. 3 and 4, the circular cutting blade 14 includes a cutting edge 24, a diameter 26, and a thickness 28. An aperture 30 extends side to side through the thickness 28 of the cutting blade 14 at the center of the blade 14. The cutting blade 14 is pivotally mounted on an axle 32 (see FIG. 1) extending through the aperture 30 and into the head portion 18. Alternatively, the axle 32 is fixed to the cutting blade 14 and the axle 32 is pivotally mounted to the head portion 18. In all embodiments, the cutting blade 14 has a diameter 26 that is not greater than about fifteen (15) times the thickness 28 of the cutting blade 14. In fact, the diameter 26 of the cutting blade 14 is preferably not more than ten (10) times the thickness 28 of the cutting blade 14. It is our experience that a cutting blade diameter 26 of approximately six (6) times the thickness 28 of the blade 14 is preferable for paper product type thin sheet material.

The cutting edge 24 of the cutting blade 14 includes a first side surface 34 and a second side surface 36 that intersect each other at a broad edge angle “α”. Each surface 34, 36 extends from a side 38, 40 of the blade thickness 28 to the intersecting point 42. The edge angle “α” formed between the two surfaces 34, 36 is in the range of about forty (40) to fifty (50) degrees, and more preferably in the range of forty-three (43) to forty-seven (47) degrees. The exact edge angle “α” of the cutter blade 14 may vary depending upon the application on hand. It is our experience that an edge angle “α” of approximately forty-five (45) degrees is preferable for paper product type thin sheet material.

Referring to FIGS. 5 and 6, in an alternative embodiment of the present invention, the cutting blade 14 is mounted in a clip 44 and the clip 44, in turn, attaches to the handle 12. The clip 44 is U-shaped and includes an axle 46 on which the cutting blade can rotate. In some instances, a pair of flanges 48 are formed along the edges of the clip 44 adjacent the cutting blade 14. The flanges 48 help keep objects away from the cutting blade 14. The clip 44 and cutting blade 14 form a replaceable unit that can be exchanged when the cutting blade 14 becomes dull. The clip 44 is received within a pocket disposed within the head portion 18 of the handle 12, and can be held there by press fit, detent, or other means.

Although this invention has been shown and described with respect to the detailed embodiments thereof, it will be understood by those skilled in the art that various changes in form and detail thereof may be made without departing from the spirit and the scope of the invention. For example in the above Detailed Description, the present invention rotary cutter has been described as being a hand-held device that includes a handle and the cutting blade. In other embodiments, the present cutting blade 12, may also be used in a manual cutting device that is not hand-held (e.g., a board device where the cutting blade 14 is supported by an arm), or a powered device where the cutting blade is rotated by a power source.

What is claimed is:

1. A hand-held rotary cutter for cutting thin sheet materials, comprising:
a handle having a hand grip portion; and
a circular cutting blade having a cutting edge, a diameter, and a thickness, wherein the cutting blade is pivotally mounted to the handle;
wherein the diameter of the cutting blade is not greater than fifteen times the thickness.

2. The hand-held rotary cutter of claim 1 wherein the diameter of the cutting blade is not greater than ten times the thickness.

3. The hand-held rotary cutter of claim 2, wherein the cutting edge includes an edge angle that is not less than forty degrees and not greater than fifty degrees.

4. The hand-held rotary cutter of claim 3, wherein the cutting edge includes an edge angle that is not less than forty-three degrees and not greater than forty-seven degrees.

5. The hand-held rotary cutter of claim 4, wherein the cutting edge includes an edge angle that is substantially equal to forty-five degrees.

6. The hand-held rotary cutter of claim 1 wherein the diameter of the cutting blade is substantially equal to six times the thickness.

7. The hand-held rotary cutter of claim 6, wherein the cutting edge includes an edge angle that is not less than forty degrees and not greater than fifty degrees.

8. The hand-held rotary cutter of claim 7, wherein the cutting edge includes an edge angle that is not less than forty-three degrees and not greater than forty-seven degrees.

9. The hand-held rotary cutter of claim 8, wherein the cutting edge includes an edge angle that is substantially equal to forty-five degrees.

10. The hand-held rotary cutter of claim 1, wherein the cutting edge includes an edge angle that is not less than forty degrees and not greater than fifty degrees.

11. The hand-held rotary cutter of claim 10, wherein the cutting edge includes an edge angle that is not less than forty-three degrees and not greater than forty-seven degrees.

12. The hand-held rotary cutter of claim 11, wherein the cutting edge includes an edge angle that is substantially equal to forty-five degrees.

13. A hand-held rotary cutter for cutting thin sheet materials, comprising:
a handle having a hand grip portion; and
a replaceable cutting blade and clip assembly, wherein the cutting blade includes a diameter and a thickness, and the diameter is not greater than fifteen times the thickness, and the cutting blade is rotatably mounted on the clip;
wherein the cutting blade and clip assembly is attached to the handle and can be selectively replaced.

14. The hand-held rotary cutter of claim 13 wherein the diameter of the cutting blade is not greater than ten times the thickness.

15. The hand-held rotary cutter of claim 14, wherein the cutting edge includes an edge angle that is not less than forty degrees and not greater than fifty degrees.

16. The hand-held rotary cutter of claim 15, wherein the cutting edge includes an edge angle that is not less than forty-three degrees and not greater than forty-seven degrees.

17. The hand-held rotary cutter of claim 16, wherein the cutting edge includes an edge angle that is substantially equal to forty-five degrees.

18. A hand-held rotary cutter for cutting thin paper products, comprising:
a handle having a hand grip portion; and
a circular cutting blade having a cutting edge, a diameter, and a thickness, wherein the cutting blade is pivotally mounted to the handle;
wherein the diameter of the cutting blade is not greater than fifteen times the thickness.

19. The hand-held rotary cutter of claim 18 wherein the cutting edge includes an edge angle that is not less than forty degrees and not greater than fifty degrees.

20. A rotary cutter for cutting thin sheet materials, comprising:
a support member; and
a circular cutting blade having a cutting edge, a diameter, and a thickness, wherein the cutting blade is pivotally mounted to the support member;
wherein the diameter of the cutting blade is not greater than fifteen times the thickness.

21. The rotary cutter of claim 20, wherein the diameter of the cutting blade is not greater than ten times the thickness.

22. The rotary cutter of claim 21, wherein the cutting edge includes an edge angle that is not less than forty degrees and not greater than fifty degrees.

23. The rotary cutter of claim 22, wherein the cutting edge includes an edge angle that is not less than forty-three degrees and not greater than forty-seven degrees.

24. The rotary cutter of claim 23, wherein the cutting edge includes an edge angle that is substantially equal to forty-five degrees.
